(19) United States
(12) Patent Application Publication
(10) Pub. No.: US 2008/0229584 A1
(43) Pub. Date: Sep. 25, 2008

(54) Pipe Cutting Apparatus

(76) Inventor: Benjamin Ronald Walter Fermor Shepherd, Devon (GB)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/092,499

(22) PCT Filed: Nov. 3, 2006
(86) PCT No.: PCT/GB06/04101

§ 371 Date: May 2, 2008

(30) Foreign Application Priority Data
Nov. 3, 2005 (GB) 0522441.5

(51) Int. Cl. B23D 21/00; B23D 21/06; B23D 21/08

(52) U.S. Cl. 30/99; 30/95; 30/101

(57) ABSTRACT

Pipe cutting apparatus (2) in which a pipe is clamped in a holder (4) and cut transverse to its longitudinal axis by a cutting head 6. The cutting head (6) is supported on the holder (4) and is rotatable around the pipe to cut the pipe wall with a blade (38). The blade (38) is advanced radially by an indexing mechanism (40) in response to rotation of the cutting head (6) around the pipe. The indexing mechanism (40) has a snail cam (44) rotatable to advance the blade (38) in response to indexing movement of a ratchet (48) controlled by a pawl (50) mounted on the holder (2) to advance the ratchet (48) on completion of each revolution of the cutting head (6). The blade (38) is withdrawn when the pipe is cut and has a stop (60) that engages a cut-out (61) in the snail cam (44) to block indexing movement of the ratchet (48) and re-set the cutting head (6).

This invention relates to pipe cutting apparatus and to a method of cutting a pipe.

New pipes are used in a variety of situations for the transportation of fluid media. A variety of PVC or PVCu pipes are used in the domestic and business situations for the removal of wastewater and soil waste or the supply of clean water. Typically such pipes have a diameter of 110 mm or 150 mm. Other sizes of plastic pipe may be used within a building for the supply or removal of water.

Plastic piping may also be used for the transportation of water in a so-called water main. Gas mains pipes are sometimes made of plastic. Alternatively, water and/or gas mains pipes may be made of plastic covered resin. Other pipes may be made of clay stoneware or may be metal, for example steel or copper.

In the creation or repair of a pipework system it is necessary to cut and joint lengths of pipe, whatever the material of the pipe. Conventionally this has been done using a cutting apparatus manipulated by an operator and requiring repeated settings and adjustments to achieve the desired cut. This process can be awkward, fiddly and relatively time-consuming.

It is an object of the invention to provide an apparatus that simplifies pipe cutting.

According to a first aspect of the invention, there is provided a pipe cutting apparatus comprising a holder for receiving a pipe to be cut, and cutting means, the cutting means and the pipe being relatively rotatable with respect to one another to perform a cut, wherein the depth of cut by the cutting means is responsive to the number of rotations.

An advantage of the present invention is that a pipe can be rapidly cut with minimal input from the operator.

Preferably, the holder comprises two half shells pivoted together so that the holder can be opened to insert the pipe and closed to clamp the pipe in position to be cut. Adjustment means may be provided such that the holder can be arranged to clamp pipes having a variety of diameters.

In a preferred embodiment the cutting means rotates with respect to the pipe. It may be desirable to provide a drive means to rotate the cutting means around the pipe. The drive means may be manually powered or may be powered by any selected one of a number of different power sources. The power source may be fixed or removable. A particularly preferred power source utilises an electric power drill.

The cutting means may be arranged to cut pipes having a variety of different diameters and/or wall thicknesses. If the variation in diameter and/or wall thickness is too large, an alternative cutting means may be substituted, the alternative cutting means being sized for larger or smaller pipes as required but identical in other respects. If the variation is greater than can be accommodated in one apparatus an alternative, larger or smaller apparatus can be substituted.

The cutting means preferably cuts the pipe transverse to its length. The cutting means may also perform one or more additional operations to one or both cut ends of the pipe. In some embodiments, the cutting means may apply a bevel to one or both faces of the cut ends of the pipe.

Preferably, the or each bevel is angled at 17 degrees although other angles—larger or smaller—may be employed without departing from the invention. In some embodiments, the cutting means may provide a partial cut in the outer surface of the pipe axially spaced from one or both cut ends of the pipe. The partial cut may facilitate removal of an outer layer or layers of the pipe such as a plastic coating from a resin pipe to allow the pipe to be joined by butt-fusion. In some embodiments, the cutting means may remove irregularities from the outer surface of the pipe to provide one or both cut ends of the pipe with a clean, smooth outer surface of substantially uniform diameter to allow the pipe to be joined by electro-fusion. In some embodiments, where a further operation on the cut end of the pipe is not required, the cutting means may perform a straight cut only to the pipe.

Preferably, the cutting means is provided with a control means for controlling operation of the cutting means. The control means may comprise an initiation means, an indexing means and a termination means.

Preferably, the indexing means is operable to advance the cutting means towards the pipe in response to rotation of the cutting means around the pipe. In a preferred embodiment, the indexing means advances the cutting means for each complete revolution of the cutting means around the pipe. The indexing means may comprise a cam for advancing the cutting means and a ratchet co-operable with a pawl on rotation of the cutting means around the pipe to provide indexing movement of the cam. Any other suitable indexing means may be employed, for example an optical device to detect relative rotation of the cutting means and pipe and advance the cutting means in response thereto by means of a cam or any other device.

Preferably, the termination means terminates revolution of the cutting means around the pipe after the cut has been completed. Preferably, the cutting means is re-set after the cut has been completed. In a preferred embodiment, the termination means includes stop means to prevent rotation of the cutting means after the cutting means has been re-set with the stop means being released by the initiation means when it is desired to start a cut.

Preferably, the cutting means includes a blade biased to a withdrawn “start” position, the blade being advanced by the indexing means against the biasing in response to rotation of the cutting means around the pipe and, on completion of the cut, the indexing means permits the blade to return to the withdrawn “start” position under the biasing.

Use of the pipe cutting apparatus according to the invention enables a swift and effective cut to be achieved. The apparatus may be used to cut and prepare new pipework. It may also be used in environments where repairs are needed and the ends of the pipe are buried in the ground. Up till now, the only method of repair was to use a hand saw to cut the pipe in situ. Apparatus according to the invention may be used to rapidly and automatically cut the pipe in-situ by digging a trench around the pipe sufficient to locate the apparatus around the pipe and for the cutting means to rotate around the pipe.

Pipe cutting apparatus according to the invention may produce a straight cut edge or at least one cut edge with a bevel. A cut edge with a bevel is particularly desirable in preparing pipes for jointing with compression type joints to enable a fluid tight joint to be made.

Pipe cutting apparatus according to the invention may also be used in preparing pipes for jointing with heat welding to soften the material of the pipe. In one type of heat welding known as electro fusion an electric current is passed through a wire coil placed around the outside of the pipe to heat and soften the material of the pipe. The wire coil may be built into the socket of a pipe coupling in which the cut end of the pipe is inserted. The apparatus according to the invention may produce a straight cut edge and clean the outer surface of the pipe ready for electro-fusion. In another type of heat welding known as butt fusion the end faces of two pipes to be joined are heated by a platen or similar device inserted between the end faces to soften the material of the pipes, the platen removed and the end faces pushed together. The apparatus according to the invention may produce a straight cut edge for butt fusion and, where necessary, a partial cut edge spaced therefrom to allow an outer coating of a material unsuitable for butt fusion to be stripped from the pipe prior to jointing.

According to a second aspect of the invention, there is provided a method of cutting a pipe comprising the steps of placing a section of pipe to be cut in pipe cutting apparatus according to the first aspect of the invention, clamping the pipe in position, operating the apparatus to cut the pipe, and disengaging the pipe cutting apparatus from the cut pipe.

The method may further comprise preparing a pipe to be cut. The pipe may be marked to indicate the cutting position. It may be desirable to excavate a trench around an in situ pipe. In some methods a further operation may be carried out while cutting the pipe. For example, if a bevel is desired and the method may further comprise the step of utilising a blade such that the cut and bevel are produced in the cutting movement. Alternatively or additionally, if a clean, smooth outer surface is required, the method may further comprise the step of utilising a stripper blade to remove surface irregularities from the pipe. Alternatively or additionally, if removal of a part of the outer surface of the pipe is required, the method may further comprise the step of utilising a blade for producing a partial cut in the outer surface of the pipe axially spaced from the cutting position.

According to a third aspect of the invention, there is provided pipe cutting apparatus comprising a holder for a pipe to be cut and cutting means, the cutting means and the pipe to be cut being rotatable with respect to one another to perform the cut, wherein the cutting means comprises a cutting blade for cutting the pipe and a stripper device for preparing an outer surface of the pipe.

Preferably, the cutting blade cuts the pipe at substantially 90 degrees to the axial direction of the pipe, and the stripper device comprises at least one blade that extends axially with respect to the pipe to be cut and removes irregularities from the outer surface of the pipe. In this way, the pipe is provided with a clean, smooth outer surface adjacent to the cut end.

According to a fourth aspect of the invention, there is provided a method of cutting a pipe by relative rotation between the pipe and a pipe cutter wherein the pipe cutter also performs a stripping action to remove irregularities from the outer surface of the pipe.

The pipe cutting apparatus and method of the third and fourth aspects of the invention may be particularly suitable for preparation of pipes for electro-fusion where the outer surface of the pipe is heated by passing an electric current through a wire coil placed around the outer surface of the pipe to cause the material of the pipe to soften and flow to form a joint. Such joints require the outer surface of the pipe to be clean, smooth and of substantially uniform diameter.

According to a fifth aspect of the invention, there is provided pipe cutting apparatus comprising a holder for a pipe to be cut and cutting means for cutting the pipe at a cutting position, the cutting means and the pipe to be cut being rotatable with respect to one another to perform the cut at the cutting position, wherein the cutting means partially cuts the pipe at a position axially spaced from the cutting position.

Preferably, the cutting means comprises a blade having a leading edge to cut the pipe at the cutting position and a trailing edge on one or both sides set back from the leading edge and axially spaced therefrom such that the or each trailing edge produces a partial cut in the outer surface of the pipe axially spaced from the cutting position.

According to a sixth aspect of the invention, there is provided a method of cutting a pipe at a cutting position by relative rotation between the pipe and a pipe cutter wherein the pipe cutter also performs a partial cut in the outer surface of the pipe axially spaced from the cutting position.

The pipe cutting apparatus and method of the fifth and sixth aspects of the invention may be particularly suitable for preparation of plastic coated resin pipes for butt-fusion where the partial cut is chosen to allow a length of the plastic coating to be stripped from the pipe to allow the resin material of the pipe to be joined by butt-fusion without contamination of the joint area by the plastic coating. Plastic coated resin pipes are commonly used for gas and water mains and these aspects of the invention allow such pipes to be prepared for jointing in a simple, reliable manner.

According to a seventh aspect of the invention, there is provided pipe cutting apparatus comprising a holder for receiving a pipe to be cut, and cutting means for cutting the pipe wherein the holder is configured to clamp the pipe at two axially spaced positions from the cutting means on the same or different sides of the cutting means.

In one embodiment, the holder comprises first and second clamps on the same side of the cutting means. Each clamp preferably comprises a pair of half-shells connected together for pivotal movement to open the holder to insert/remove a pipe into the holder and to close the holder to clamp the pipe. The clamps may be linked to open and close together.

In another embodiment, the holder comprises a first clamp on one side of the cutting means and a second clamp on the other side of the cutting means. Each clamp preferably comprises a pair of half-shells connected together for pivotal movement to open the holder to insert/remove a pipe into the holder and to close the holder to clamp the pipe. The second clamp may be demountable.

According to an eighth aspect of the invention, there is provided pipe cutting apparatus comprising an openable holder for receiving a pipe to be cut, means for clamping the pipe in the holder and means for cutting the pipe when clamped so as to provide and cut at 90 degrees to its axis and at the same time applying a bevel to the pipe end.

According to a ninth aspect of the invention, there is provided a method of cutting a pipe comprising the steps of placing a section of pipe to be cut in a pipe cutting apparatus according to the eighth aspect of the invention, clamping the pipe in position, operating the apparatus to cut the pipe and apply a bevel to one or both cut ends of the pipe, and disengaging the pipe cutting apparatus from the cut pipe.

Preferably, the method includes the step of providing a cutting blade with a leading edge for cutting the pipe substantially transverse to a longitudinal axis of the pipe and at least one trailing edge set back from the leading edge for applying a bevel to a cut end of the pipe. In an especially preferred embodiment, the cutting blade has trailing edges on both sides of the leading edge to apply a bevel to both cut ends of the pipe.

According to a tenth aspect of the invention, there is provided a method of preparing one or more pipes for jointing comprising the steps of cutting one or more sections of pipe using pipe cutting apparatus according to the first aspect of the invention, and configuring the cutting means to carry out a further operation on one or both cut ends of the pipe.

The further operation may form a bevel on the end faces of one or both cut ends of the pipe. Alternatively or additionally, the additional operation may provide a partial cut in the outer surface of one or both cut ends of the pipe, the partial cut being axially spaced from the cut end. Alternatively or additionally, the additional operation may remove surface irregularities from the one or both sides of the cut.

According to an eleventh aspect of the invention, there is provided a pipe cutting apparatus comprising a holder for receiving a pipe to be cut, cutting means for cutting the pipe, the cutting means and the pipe being relatively rotatable with respect to one another to perform a cut, and means controlling the depth of the cut by the cutting means in response to relative rotation of the pipe and cutting means.

Preferably, the cutting means is rotatable around the pipe and the control means includes an indexing mechanism for adjusting the cutting means to alter the cutting depth in response to rotation of the cutting means. The indexing means may be responsive to each complete revolution of the cutting means around the pipe.

Embodiments of the invention will now be described in more detail, by way of example only, with reference to the accompanying drawings in which like reference numerals are used throughout to indicate corresponding parts and wherein:

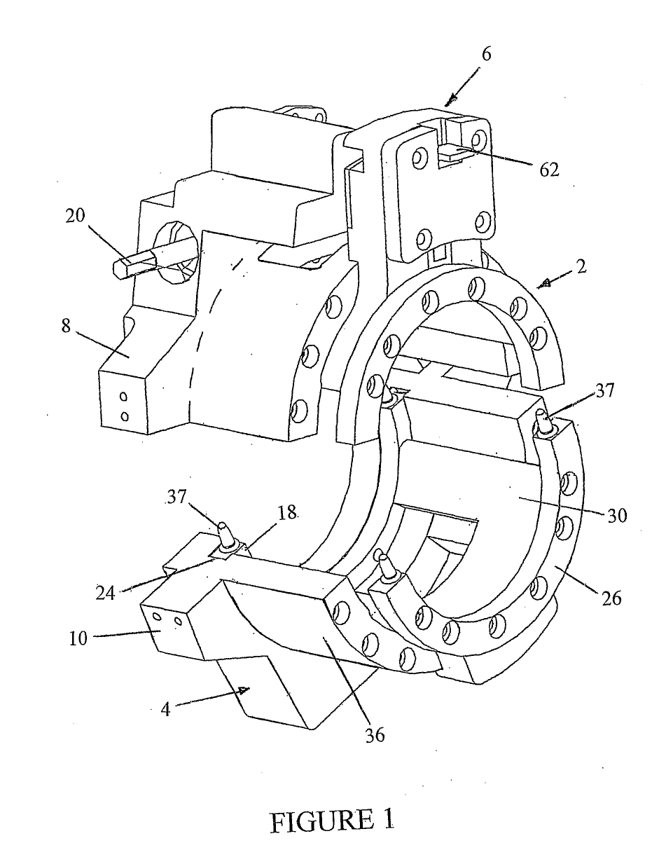

FIG. 1 is a perspective view of pipe cutting apparatus according to a first embodiment of the invention, the apparatus being shown in an open position;

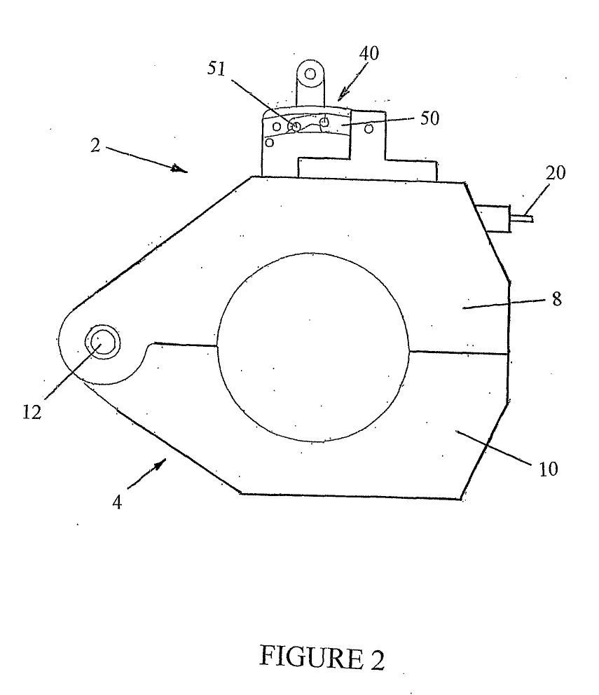

FIG. 2 is an end view of the pipe cutting apparatus shown in FIG. 1, the apparatus being shown in a closed position;

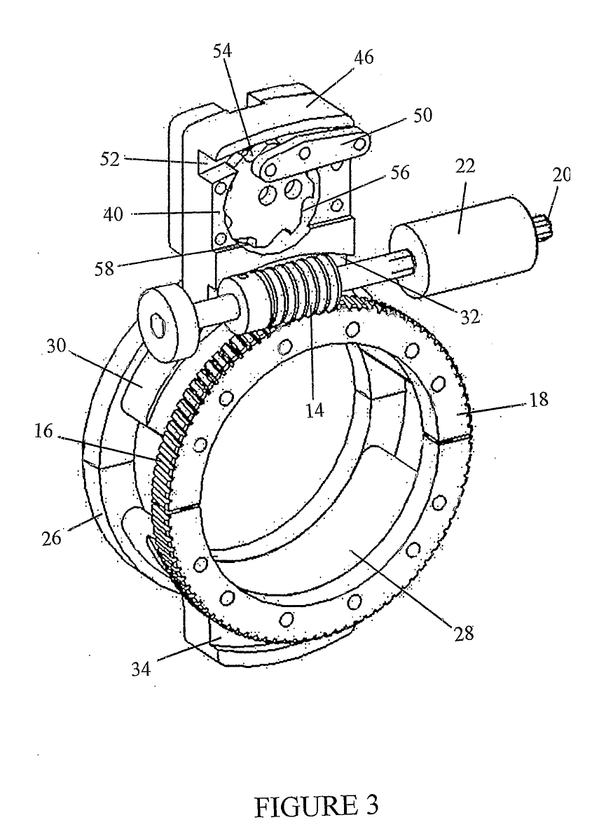

FIG. 3 is a perspective view of the cutting head of the apparatus shown in FIG. 1;

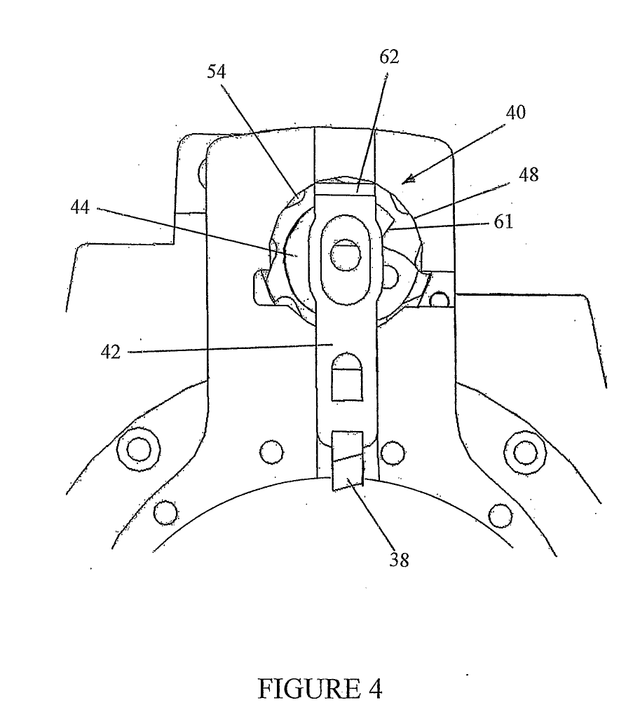

FIG. 4 shows a detail of the cutting head shown in FIGS. 1 to 3;

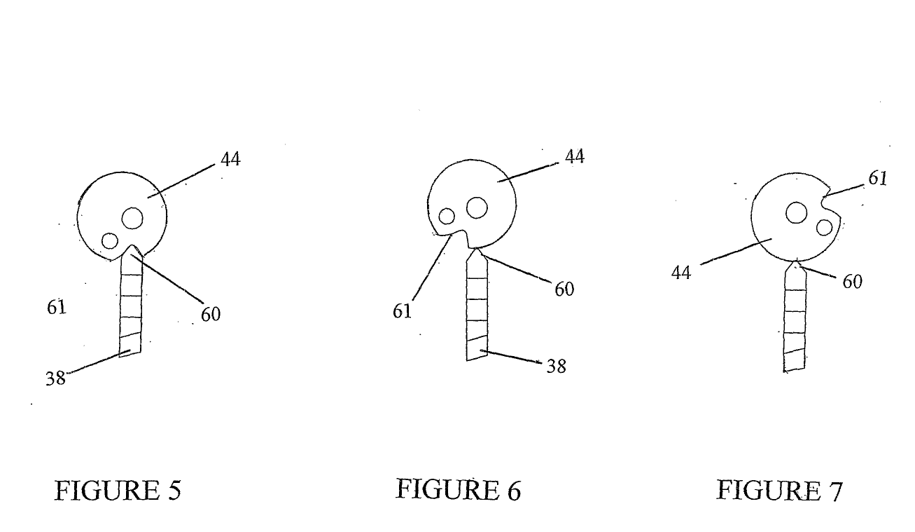

FIGS. 5 to 7 show different positions of the snail cam and cutting blade shown in FIG. 4;

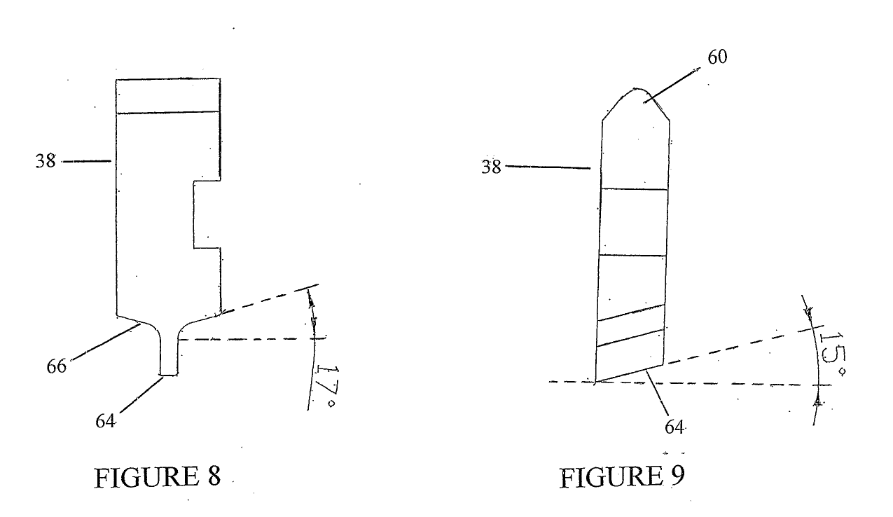

FIG. 8 is an end view of the cutting blade shown in FIG. 4;

FIG. 9 is a side view of the cutting blade shown in FIG. 4;

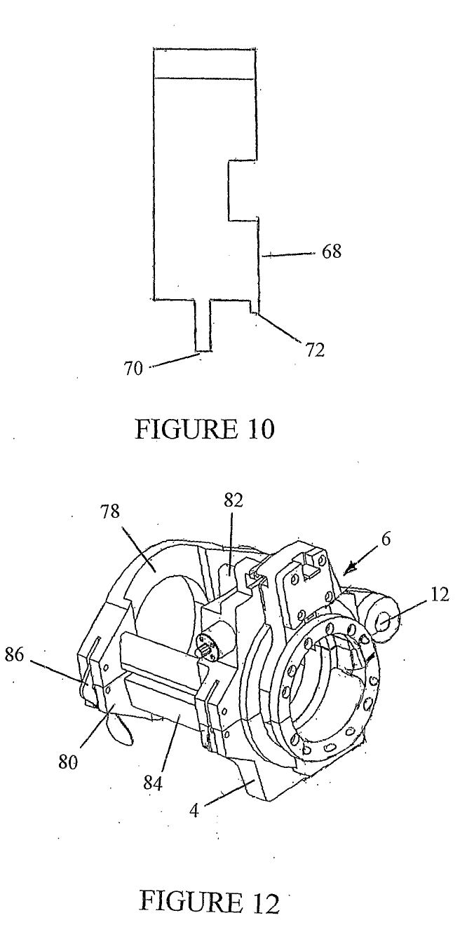

FIG. 10 is an end view of an alternative cutting blade;

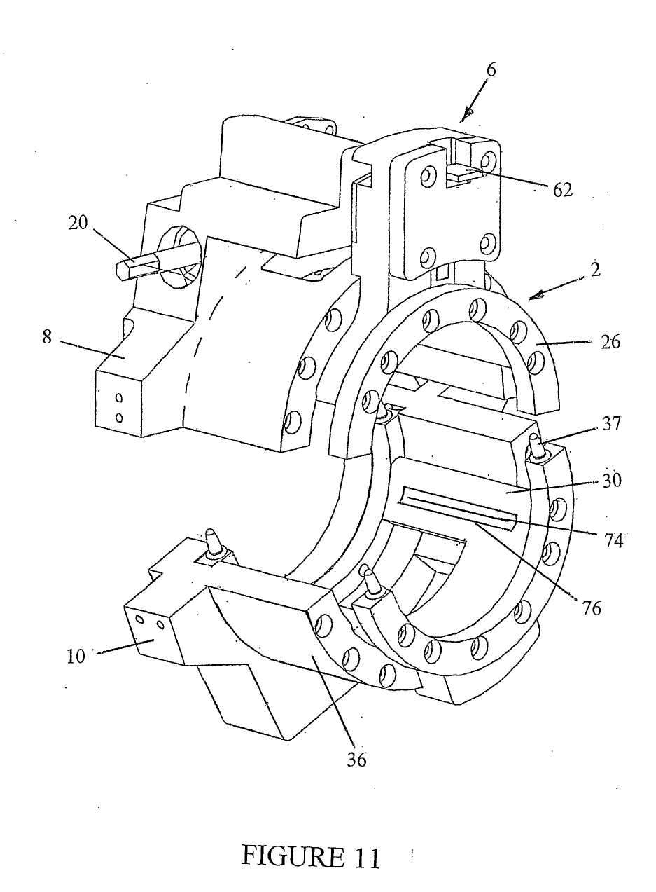

FIG. 11 is a perspective view, similar to FIG. 1, showing a modification of the apparatus to include a stripping blade;

FIG. 12 is a perspective view of pipe cutting apparatus according to a second embodiment of the invention, the apparatus being shown in a closed position; and

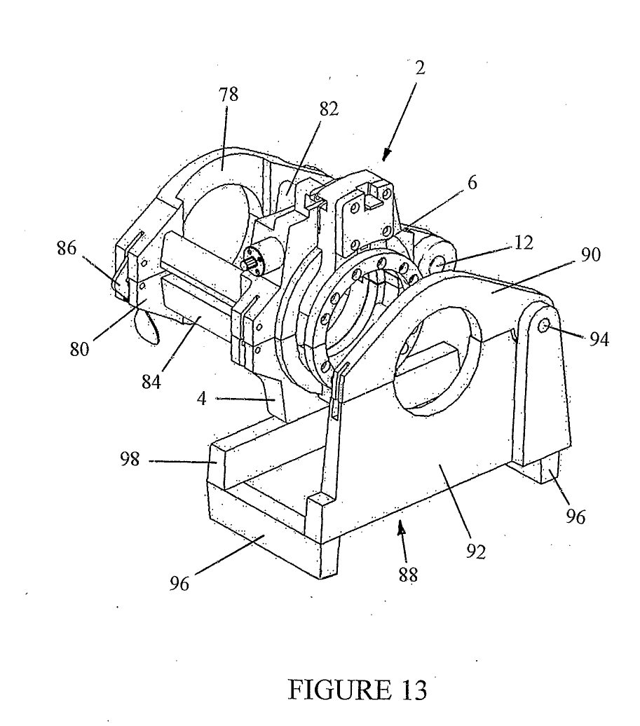

FIG. 13 is a perspective view of pipe cutting apparatus according to a third embodiment of the invention, the apparatus being shown in a closed position.

Referring first to FIGS. 1 to 7 of the accompanying drawings, there is shown a first embodiment of pipe cutting apparatus 2 suitable for cutting a pipe (not shown) in situ, for example when it is desired to effect a repair to and/or to make a joint in an existing length of pipe. The apparatus 2 comprises a holder 4 on which a cutting head 6 is rotatably mounted.

The holder 4 comprises two half shells 8,10 connected together by a hinge 12 for pivotal movement between an open position shown in FIG. 1 in which the apparatus can be fitted to/removed from a section of pipe and a closed position in FIG. 2 in which the apparatus is secured to the pipe for cutting the pipe with the cutting head 6 as described in more detail later. A closure device (not shown) is provided to secure the two half shells 8,10 in the closed position in which the holder 4 is clamped to the pipe. Any suitable device could be employed to secure the half-shells 8,10 in the closed position. Thus, for smaller sizes of pipes, a manually operable over centre lever arrangement may be employed while for larger sizes of pipes, a powered device such as a hydraulically, pneumatically or electrically operated ram may be employed. The holder 4 may be provided with a registration mark (not shown) for alignment with a mark on the pipe indicating the position where the pipe is to be cut so as to locate the pipe at the correct position in the holder 4 relative to the cutting head 6. In this embodiment, the half shells 8,10 are aluminium castings but it will be understood other metals or alloys or possibly plastics material of suitable strength could be employed.

As best shown in FIG. 3, a worm gear 14 mounted in the holder 4 meshes with teeth 16 on a drive ring 18 of the cutting head 6 and is rotatable by means of a spigot 20 projecting from the holder 4 for connecting drive means (not shown) to rotate the cutting head 6 about the longitudinal axis of a pipe held in the holder 4. Any suitable drive means may be employed. For example, a lever may be detachably connected to the spigot 20 for manually rotating the cutting head 6. Alternatively, an electric motor may be attached to the spigot 20 for powered rotation of the cutting head. In a preferred embodiment, a hand held tool such as an electric drill is detachably connected to the spigot 20. It will be understood that other drive means may be employed including hydraulic, pneumatic and electric drive means. In this embodiment, drive protection means such as a clatter clutch 22 is also mounted on the spigot 20 such that any excessive torque applied to the spigot 20 by the drive means is dissipated by spring loaded ball bearings for a purpose to be described later. Alternative drive protection means may be utilised.

The drive ring 18 is located in a channel 24 in the holder 4 and is connected to a second ring 26 coaxial with the drive ring 18 by a pair of spacers 28,30. The rings 18,26 have the same internal diameter chosen to be slightly larger than the maximum external diameter of the pipe that can be accommodated in the closed position of the holder 4 to provide a small annular clearance gap, for example about b 1 mm, between the pipe and the cutting head 6 that facilitates rotation of the cutting head 6 around the pipe.

Each spacer 28,30 has a channel portion 32,34 respectively that locates over an external annular surface 36 of the holder 4 such that, as the cutting head 6 rotates, it is maintained concentric with the longitudinal axis of a pipe secured in the holder 4. The rings 18,26 are split and separate into two halves as shown in FIG. 1 when the holder 4 is opened to allow the apparatus to be fitted to/removed from a section of pipe. The engagement of the flanged portions 32,34 with the annular surface 36 assists separation of the rings 18,26 when the holder 4 is opened, and each half ring is located relative to the other half ring when the holder 4 is closed by engagement of tapered pins 37 on one half ring engaging holes (not shown) in the other half ring.

In use, as the cutting head 6 rotates, a blade 38 mounted in the cutting head 6 is advanced in a radial direction to progressively cut through the pipe. The movement of the blade 38 is controlled by an indexing mechanism 40 in response to rotation of the cutting head 6 around the pipe for adjusting the radial position of the blade 38. The blade 38 is mounted in a holder 42 biased towards a snail cam 44 by a spring (not shown) although any other suitable biasing means could be employed. The blade holder 42 and snail cam 44 are mounted in a housing part 46 of the spacer 28, and the snail cam 44 is rotatable to move the holder 42, and thus the blade 38, under the control of the indexing mechanism 40. The blade 38 is preferably detachable from the holder 40 so that a damaged or worn blade 38 can be removed and replaced.

In this embodiment, the indexing mechanism 40 includes a ratchet 48 rotatably mounted in the housing part 46 and a pawl 50 pivotally mounted on the holder 4. A portion of the peripheral edge of the ratchet 48 is received in a slot 52 in the housing part 46. On completion of each revolution of the cutting head 6, a pin 51 (FIG. 2) on the pawl 50 enters one end of the slot 52 and engages a recess 54 in the peripheral edge of the ratchet 48 causing the ratchet 48 to rotate until the pin is released from the recess 54 and exits the other end of the slot 52. The ratchet 48 has a plurality of recesses 54 in the peripheral edge that are uniformly spaced apart around the circumference and the pin of the pawl 50 sequentially engages the recesses 54 on completion of each revolution of the cutting head 6 to move the ratchet 48 on to the next position. As shown, each recess 54 has a sloping edge 56 to receive the pin of the pawl 50 terminating in a steep face 58 that prevents return.

The snail cam 44 is mounted on the ratchet 48 and rotates with the ratchet 48 to advance the blade 38 a pre-determined amount in the radial direction with each revolution of the cutting head 6. Each recess 54 corresponds to an indexing position of the blade 38 and the number of recesses 54 and profile of the snail cam 44 are chosen so that the blade 38 is advanced a distance sufficient to cut the pipe transverse to its longitudinal axis on completion of one complete revolution of the ratchet 48. In this embodiment, the ratchet 48 has eight recesses 54 uniformly spaced apart so that, on completion of each revolution of the cutting head 6, the ratchet 48 is rotated 45 degrees providing eight indexing positions for one complete revolution of the ratchet 48. It will be understood, however that the number of recesses 54 and/or the cam profile can be changed according to the wall thickness of the pipe to be cut.

On completion of one complete revolution of the ratchet 48, the snail cam 44 is returned to its original position and the blade holder 42 automatically returns to its original position withdrawing the blade 38 in a radial direction to its original position under the biasing of the spring acting on the blade holder 42. At the same time, a stop 60 (FIG. 5) on the upper end of the blade 38 automatically engages a notch 61 in the peripheral edge of the snail cam 44 to block rotation of the snail cam 44 and thereby prevent rotation of the ratchet 48. As a result, rotation of the cutting head 6 is blocked by engagement of the pin on the pawl 50 with the ratchet 48 creating a resistance to rotation of the spigot 20 that is taken up by the clatter clutch 22 preventing damage to the drive mechanism and to the indexing mechanism and also providing an indication to the operator that the cut is complete and the drive can be disconnected. In this way, the cutting head 6 is automatically re-set on completion of a cut and is ready to start the next cut without requiring the operator to move the blade 38 or adjust the indexing mechanism.

The cutting head 6 can be manually released by depressing a transverse lever 62 at the upper end of the blade holder 42 to move the blade 38 radially against the biasing to disengage the stop 60 from the notch 61 in the snail cam 44 to allow rotation of the ratchet 48 carrying the snail cam 44 in response to rotation of the cutting head 6 to advance the blade 38 when it is desired to start a cut (FIG. 6). As the cutting head 6 rotates, the snail cam 44 is rotated in a clockwise direction from the position shown in FIG. 6 in response to indexing movement of the ratchet 48 to advance the blade 38 in a radial direction (FIG. 7) to gradually cut through the wall of pipe. When the snail cam 44 returns to its original position, the stop 60 on the upper end of the blade 38 engages the notch 61 in the snail cam under the biasing of the spring acting on the blade holder 42 to block rotation of the snail cam 44 and re-set the indexing mechanism 40 (FIG. 5). Any other suitable stop device may be employed to terminate rotation of the cutting head 6 when the blade 38 and indexing mechanism 40 have been re-set on completion of a cut.

Referring now to FIGS. 8 and 9 of the drawings, the blade 38 is shown in more detail and comprises a leading edge 64 for cutting through the pipe transverse to its longitudinal axis and, set back from the leading edge 64 on either side thereof, a pair of trailing edges 66 for bevelling the cut ends of the pipe. As shown the leading edge 64 of the blade 38 extends transverse to the longitudinal axis of the pipe and at an angle relative to the surface of the pipe. This arrangement improves the cut of the pipe as the blade 38 rotates around the pipe. In this embodiment the angle is 15 degrees but it will be understood this is not essential and that other angles—larger or smaller—may be employed. The trailing edges 66 of the blade 38 extend normal to the leading edge 64 and are inclined relative to the longitudinal axis of the pipe to produce a bevelled surface on the cut ends of the pipe on either side of the blade 38. In this embodiment, the inclination of the trailing edges, and thus the bevel angle, is 17 degrees but it will be understood this is not essential and that other bevel angles—larger or smaller—may be employed. It will be appreciated that the trailing edges 66 may be inclined at the same or different angles. In some applications the blade 38 may be replaced by a blade having a trailing edge on one side only to produce a bevelled surface on one of the cut ends of the pipe, for example where the other cut end is on a section of pipe to be removed when inserting a fitting to make a joint to a new length of pipe. In other applications where a bevel is not required, the blade 38 may be replaced by a blade to cut the pipe transverse to the longitudinal axis without producing a bevelled surface on the cut ends of the pipe. Other combinations of cutting surfaces that could be employed in the invention will be apparent to those skilled in the art.

The apparatus may be adapted to cut pipes having a range of diameters up to the maximum for a given size of holder 4 by the use of shims (not shown) detachably connected to the holder 4 to reduce the internal diameter of the pipe receiving section of the holder 4 to match pipes having a smaller diameter than the maximum for the given size of holder 4. The shims ensure that the cutting head 6 is rotatable about the longitudinal axis of the pipe secured in the holder for all possible sizes of pipe that can be accommodated. The shims may be releasably attached to the holder by any suitable means. In this embodiment, the shims are attached by magnetism allowing the apparatus to be quickly converted for cutting pipes of different diameter within the permitted range of diameters. The travel of the blade 38 may be chosen so that pipes of different diameter and/or different wall thicknesses can be cut without changing the blade 38 or adjusting the indexing mechanism. Alternatively, a plurality of interchangeable blades 38 of different length may be provided for detachable mounting in the holder 40 to cut pipes of different diameter and/or wall thickness.

Referring now to FIG. 10 of the drawings, there is shown a blade 68 for use when cutting a pipe that facilitates removal of an outer layer or layers from the cut end of the pipe. The blade 68 is particularly useful when cutting plastic coated resin pipes where it is necessary to remove a section of the plastic coating to enable the cut end of the pipe to be joined to another pipe and/or a pipe fitting. As shown, the blade 68 can be detachably mounted in the holder 40 of the cutting head 6 and has a leading edge 70 for cutting the pipe transverse to the longitudinal axis as described previously. The blade 68 also has a trailing edge 72 that is set back from the leading edge 70 and axially spaced therefrom in the direction of the longitudinal axis of the pipe on one side of the blade 68. The trailing edge 72 is arranged to provide a depth of cut corresponding to or slightly less than the thickness of the plastic coating on the main body of the resin pipe at a position axially spaced from the leading edge 70 corresponding to the length of the section of the outer plastic coating to be removed from the main body of the resin pipe prior to joining the cut end of the pipe to another pipe or a pipe fitting. In this embodiment, depth of cut is approximately 1 mm and the axial spacing is approximately 25 mm but it will be understood this is not essential and that any desired depth of cut—larger or smaller than 1 mm—and/or axial spacing—larger or smaller than 25 mm—may be employed to suit the thickness of the plastic coating and/or the length of plastic coating to be removed by selection and fitment of the appropriate blade 68.

The blade 68 may be used to prepare gas or water mains pipes for butt-fusion. Gas or water mains pipes typically comprise a pipe formed from resin and coated in a layer of plastics. The plastics coating provides a smooth durable outer surface. Conventionally, the resin of the mains pipe is white for both gas and water mains and the plastic coating is either yellow for gas mains or blue for water mains. In order to carry out butt-fusion, a kind of heat welding, it is necessary to strip away all of the coloured (yellow or blue) plastic coating from the ends of the pipes to be joined. As discussed earlier, any plastics remaining in the joint may cause the joint to fail. The blade 68 enables the plastics coating to be cut at the same time the pipe is cut to facilitate removal of a suitable length of the plastics coating from the cut end of the pipe enabling a gas or water mains pipe to be rapidly prepared for butt-fusion in a simple and reliable manner.

In a modification (not shown), the blade 68 may be provided with a pair of trailing edges 72 arranged to provide partial cuts in the outer surface of the pipe axially spaced from both cut ends of the pipe. The axial spacing of the trailing edges 72 from the leading edge 70 may be the same or different and the depth of the partial cut may be the same or different.

In a further modification (not shown), the or each partial cut in the outer surface of the pipe may be provided by one or more blades mounted in the cutting head separate from the cutting blade 38. The or each partial cut blade may be biased towards the outer surface of the pipe to form a partial cut in the outer surface as the cutting head 6 rotates around the pipe. In this way, the or each partial cut blade automatically adapts to provide a partial cut of controlled depth for removing the plastics coating from the cut end of pipes of different diameter as well as pipes of non-uniform outer diameter, for example pipes having a slightly oval cross-section.

Referring now to FIG. 11 of the drawings, there is shown a modification to the pipe cutting apparatus shown in FIGS. 1 to 7. In this modified form of the apparatus, the cutting head 6 is provided with an elongate stripping blade 74 located in a slot 76 in the spacer 30. The slot 76 extends parallel to the longitudinal axis of the pipe to be cut and the stripping blade 74 is rotatable about an axis parallel to the longitudinal axis of the pipe by a drive mechanism (not shown) coupled to the spigot 20 by any suitable means. The stripping blade 74 may be geared to rotate at the same speed as the cutting head 6 or may rotate at a different speed. Preferably the stripping blade 74 rotates faster than the cutting head 6.

The stripping blade 74 projects from the slot 76 towards the pipe so as to just contact the outer surface of the pipe such that, as the cutting head 6 rotates around the pipe, the stripping blade 74 rotates about its longitudinal axis to clean the outer surface of the pipe and remove any projections or irregularities. In this way, the cut end of the pipe is provided with an axially extending end section having a clean and smooth outer surface of uniform diameter.

In this embodiment, the stripping blade 74 is rotatably mounted on a carrier (not shown) that is pivotal to raise/lower the stripping blade 74 relative to the internal surface of the cutting head to adjust the height the stripping blade 74 projects from the internal surface. The stripping blade 74 may comprise a single blade but more preferably takes the form of a cutting cylinder with a plurality of blades extends lengthwise of the cylinder and spaced apart around the circumference to contact sequentially the outer surface of the pipe as the cylinder rotates. The stripping blade 74 is preferably detachable to allow a damaged or worn blade to be replaced and may be biased towards the outer surface of the pipe. The cutting head 6 may be provided with more than one stripping blade 74 spaced apart in the circumferential direction,

The stripping blade 74 may be employed when preparing a plastics pipe for electro-fusion where the plastics is heated by an electric wire coil positioned around the outer surface of the pipe to soften the plastics to form a joint with a pipe fitting. For example, the coil may be built-into sockets in a pipe fitting to receive the cut end of the pipe to form a joint by passing an electric current through the coil to soften the plastics material of the pipe and fitting to form a fluid-tight joint. In this application, removal of surface irregularities to provide the pipe with a smooth, clean outer surface in the joint area is necessary to ensure an effective joint can be produced.

Referring now to FIG. 12 of the drawings, there is shown a second embodiment of pipe cutting apparatus 2 according to the invention in which the holder 4 comprises an additional set of half-shells 78,80 axially spaced from the half-shells 8,10 and connected thereto by longitudinally extending bars 82,84 respectively. The additional half-shells 78,80 and bars 82,84 are aluminium castings but it will be understood other metals or alloys or possibly plastics material of suitable strength could be employed. The half-shells 78,80 are connected together by a hinge (not shown) coaxial with the hinge 12 connecting the half-shells 8,10 for pivotal movement therewith to open and close the holder 4 so that the apparatus can be fitted to/removed from a section of pipe as described previously. The two sets of half shells 8,10 and 82,84 are secured in the closed position by respective over-centre lever arrangements 86 (one only shown) in which the holder 4 is clamped to the pipe at two axially spaced positions to one side of the cutting head 6. The double clamping arrangement is particularly suitable for use when cutting a pipe in situ that is not supported on both sides of the cutting head 6. In other respects, the apparatus is operable to cut a pipe as described previously and the construction and operation of the cutting head 6 will be understood from the description already provided with reference to FIGS. 1 to 10.

Referring now to FIG. 13 of the drawings, there is shown a third embodiment of cutting apparatus 2 according to the invention. The third embodiment is similar to the second embodiment shown in FIG. 10 with the addition of an auxiliary detachable holder 88 connected to the holder 4 to support and clamp the pipe on the opposite side of the cutting head 6 to the holder 4. The auxiliary holder 88 has two half-shells 90,92 connected together by a hinge 94 coaxial with the hinges of the holder 4 for movement between the closed position shown in FIG. 11 and an open position for fitting the apparatus to and removing the apparatus from a pipe to be cut. The half shells 90,92 are secured in the closed position by an over-centre lever arrangement (not shown) similar to the lever arrangement 86 of the holder 4. The auxiliary holder 88 is supported on a pair of laterally spaced longitudinally extending bars 96 that are connected to a transverse bar 98 that in turn is releasably connected to the underside of the holder 4 such that the auxiliary holder 88 is axially spaced from the cutting head 6. In this embodiment, the pipe is clamped on both sides of the cutting head 6. This is particularly useful when cutting an unsupported section of pipe to length. In other respects, the apparatus is operable to cut a pipe as described previously and the construction and operation of the cutting head 6 will be understood from the description already provided with reference to FIGS. 1 to 10.

Although the auxiliary holder 88 has been described in combination with the holder 4 of the second embodiment, it will be understood that the auxiliary holder 88 could also be used with the holder 4 of the first embodiment. When used with the holder 4 of the first embodiment, the auxiliary holder 88 could be attached to the holder 4 on the opposite side of the cutting head 6 so that the pipe is clamped on both sides of the cutting head 6. Alternatively, the auxiliary holder 88 could be attached to the holder 4 on the same side of the cutting head 6 so that the pipe is double clamped on one side of the cutting head as in the second embodiment The auxiliary holder 88 is preferably detachable for use when required. In this way, the auxiliary holder 88 can be removed to facilitate use of the apparatus in areas where access to the pipe is restricted. It will be understood, however, that in some versions the auxiliary holder could be an integral part of the apparatus.

The pipe cutting apparatus according to the present invention is designed for the builder or plumber who needs to make additions to existing systems in a domestic, industrial or agricultural environment, or simply building new homes, factories or farm buildings. The apparatus has advantages where many cuts are needed and time is of the essence. Some embodiments are particularly applicable in situations where access is limited or awkward. For example, it is estimated that the apparatus according to the present invention can produce a finished, usable pipe end in approximately 40 seconds as opposed to using conventional methods when the time required is about 3.75 minutes. Furthermore, the pipe cutting is carried out in an automated fashion and a clean replicable cut is produced each time. Moreover, the pipe cutting may be combined with additional functions such as to produce a bevelled surface to one or both cut ends, to provide the pipe with a clean, smooth outer surface adjacent to the cut end or to provide a partial cut axially spaced from the cut end to remove an outer layer or section of the pipe.

Pipe cutting apparatus according to the invention may also be used in cutting pipe work in extreme conditions. It has been found that pipes, which are laid and used in extreme conditions and weather, are exposed to large temperature fluctuations and can often crack or spring leaks due to the expansion and contraction as a result of the temperature fluctuations. Given the inhospitable nature of the environment in which the pipes are laid this can cause problems in maintaining and repairing the pipes. Such pipes may be used for the transportation of oil or gas through Arctic, sub-Arctic and other inhospitable environments. It has been found that the inclusion of Kevlar in the pipes reduces the maintenance required. However, the inclusion of Kevlar in the pipe has caused problems in conventional methods of cutting and jointing pipes. Conventionally, large snips have been used and these do not cut but rather crush the pipe. It has been found that pipe-cutting apparatus according to the invention is particularly suitable for the cutting of pipes incorporating Kevlar in the construction.

Since operation of the pipe cutting apparatus is simple and rapid and the cutting is carried out in an automated fashion with minimal operator input, it is proposed that the pipe cutting apparatus may be suitable for the cutting of pipes in an underwater situation. It is envisaged that the apparatus could readily be provided with buoyancy tanks, which could be controlled by an operator, so enabling the pipe cutting apparatus to be used to cut pipes in situ on the seabed. The buoyancy tanks could be adjusted so that the pipe cutting apparatus is correctly positioned around a pipe before cutting commences.

The invention has been described primarily in relation to the cutting of pipes made of plastics, resins and composites thereof. It will be understood that the pipe cutting apparatus may also be used for the cutting of stoneware, clay and metal pipes.

While the invention has been described with reference to preferred embodiments, it will be understood that the invention is not limited thereto. For example, the holder may comprise one or more parts that can be expanded in a radial direction to open the holder to allow a pipe to inserted lengthwise into the holder without separating the parts and then contracted to close the holder and clamp the pipe in position. This arrangement allows a range of pipes of different diameter to be accommodated but requires the pipe to have a free end for fitting the apparatus whereas the half-shells of the holders in the exemplary embodiments allow the apparatus to be fitted around a pipe where there is no free end. The cutting head is preferably rotatable around the pipe to allow use of the apparatus where, for example, the pipe is fixed in situ or when cutting a length of pipe from a coiled stock of pipe. For some applications, however, it is envisaged that the pipe could rotate relative to the cutting head with the cutting blade being advanced to cut the pipe in response to rotation of the pipe,

Other modifications that can be made without departing from the scope of the invention as defined in the claims will be apparent to those skilled in the art. It will also be understood that the pipe cutting apparatus of the invention may comprise features of any of the embodiments separately or in combination with features of any other embodiment and all such arrangements are deemed within the scope of the invention.

1. Pipe cutting apparatus comprising a holder for receiving a pipe to be cut, and cutting means, the cutting means and the pipe being relatively rotatable with respect to one another to perform a cut, wherein the depth of cut by the cutting means is responsive to relative rotation of the cutting means and pipe.

2. Pipe cutting apparatus as claimed in claim 1 in which the cutting means rotates with respect to the pipe.

3. Pipe cutting apparatus according to claim 1 in which a drive means drives the cutting means.

4. Pipe cutting apparatus according to claim 1 in which the cutting means is controlled by a control means.

5. Pipe cutting apparatus according to claim 4 in which the control means includes an indexing means for controlling the depth of cut by the cutting means.

6. Pipe cutting apparatus according to claim 5 in which the indexing means advances the cutting means towards the pipe to be cut in response to relative rotation of the cutting means and pipe, and the indexing means advances the cutting means for each complete revolution of the cutting means around the pipe.

7. (canceled)

8. Pipe cutting means according to claim 6 wherein the indexing means comprises a cam for advancing the cutting means and a ratchet co-operable with a pawl on rotation of the cutting means around the pipe to provide indexing movement of the cam.

9. Pipe cutting apparatus according to claim 8 wherein the ratchet is configured to advance the cutting means to complete the cut on completion of one revolution of the ratchet.

10. (canceled)

11. Pipe cutting apparatus according to claim 4 wherein the control means includes initiation means for permitting relative rotation of the cutting means and the pipe when it is desired to start a cut, and termination means to terminate relative rotation of the cutting means and the pipe after the cut has been completed.

12. Pipe cutting apparatus according to claim 4 wherein the control means is operable to re-set the cutting means after the cut has been completed.

13. Pipe cutting apparatus according to claim 4 wherein the cutting means is biased away from the pipe, the biasing acting to withdraw the cutting means when the cut is completed.

14. Pipe cutting apparatus according to claim 1 wherein the cutting means includes a blade having a leading edge for cutting the pipe substantially transverse to a longitudinal axis of the pipe.

15. Pipe cutting apparatus according to claim 14 wherein the blade has a trailing edge set back from the leading edge for performing an additional cut.

16. Pipe cutting apparatus according to claim 15 wherein the trailing edge provides a bevel to a cut end face of the pipe.

17. Pipe cutting apparatus according to claim 15 wherein the trailing edge provides a partial cut in the pipe axially spaced from the cut produced by the leading edge.

18. Pipe cutting apparatus according to claim 1 wherein the cutting means includes a stripping blade for removing irregularities from the outer surface of the pipe.

19. Pipe cutting apparatus according to claim 1 wherein the holder is openable to insert/remove a pipe to be cut and clamps the pipe when closed.

20. Pipe cutting apparatus according to claim 1 wherein the holder is provided with adjustment means for clamping pipes of varying diameters.

21. Pipe cutting apparatus according to claim 1 wherein the cutting means includes a cutting head rotatably supported on the holder.

22. (canceled)

23. Pipe cutting apparatus comprising a holder for receiving and clamping a pipe to be cut, cutting means for cutting the pipe and drive means for driving the cutting means, the cutting means being configured to rotate within the holder relative to the pipe and including a blade operable in response to rotation of the cutting means to move in radial direction to cut the pipe.
